(19) United States
(12) Patent Application Publication
(10) Pub. No.: US 2002/0103655 A1
(43) Pub. Date: Aug. 1, 2002

(54) Method for a utility providing electricity via class of service

(75) Inventors: Stephen J. Boies, Mahopac, NY (US); Samuel H. Dinkin, Austin, TX (US); David Perry Greene, Ossining, NY (US); Paul Andrew Moskowitz, Yorktown Heights, NY (US); Edith Helen Stern, Yorktown Heights, NY (US); Barry Edward Willner, Briarcliff Manor, NY (US); Philip Shi-lung Yu, Chappaqua, NY (US)

Correspondence Address: Carstens, Yee and Cahoon, L.L.P., P.O. Box 802334, Dallas, TX, 75380, US

(73) Assignee: International Business Machines Corporation, Armonk, NY (US)

(21) Appl. No.: 09/772,646

(22) Filed: Jan. 30, 2001

(51) Int. Cl. G06F 17/60

(52) U.S. Cl. 705/1; 705/7

(57) ABSTRACT

The present invention provides a system and method for a utility or a service vendor to provide electricity via a class of service. The system and method provide a mechanism by which power is supplied to customers via prioritized classes of importance wherein the point of utilization communicates with the electrical power supply network and provides information for the utility to determine whether or not power needs to be supplied to a specific outlet or appliance during various electrical demand or rate periods.

### BACKGROUND OF THE INVENTION

1. Technical Field

The present invention relates to improving energy management and electrical automation systems in the provision and conservation of electrical power. Specifically, the invention provides a method of monitoring and regulating electrical power supplied to end-users based upon established levels of service.

2. Description of Related Art

For some years, there has been a great deal of interest in achieving more efficient utilization of electrical power generation capabilities and more sophisticated control of electrical loads by users. With a growing awareness of the ecological impact and economic cost of inefficient utilization of resources, electrical power customers have become aware of the desirability of altering their usage patterns. Some power companies offer various electricity price rates, which vary according to the time of day, to encourage customers to operate appliances such as pool pumps and dishwashers during off-peak times.

Generally, a high rate is charged during certain hours of peak demand and a lower rate is charged during other hours of off-peak demand. An alternative approach would permit extension of time-of-day rate setting to allow more frequent (e.g., hourly) changes in rates. This rate system for power would require that the customer be advised of each rate change and then decide what appliances the customer is willing to operate at such a rate. To automate this process, it is necessary that the power customer be able to monitor and control power usage by the more significant loads in the customer's residence or business.

The cost of alternating current (AC) electrical power paid by the end customer is generally dependent upon both the energy consumed (e.g. measured in kilowatt hours) over a billing period (e.g. each month), and also the peak power consumption (e.g. measured in kilowatts). Since the rates charged for electric energy are at least in part a function of system-wide demand at the time (as, for example, reflected in fuel cost), a customer with a fixed budget can afford to consume more power when rates are low than it can when rates are higher. Therefore, such a customer may wish to be able to make usage decisions which are rate-dependent. Of course, if rates can be changed by the utility company at any time, the customer is not likely to want to sit around listening to or watching broadcasts of rate information. An automatic response to rate broadcasts would be desirable. Such an automatic response could assume many forms and might be conditioned not only on the newly announced rate, but also on other factors, such as the sensed temperature or time of day or urgency of a task (e.g., appliance priority level). Therefore, a need exists for an improved method of allowing customers or a service provider to negotiate the level of electrical service available to the customer system in light of variable electrical rates during peak and off-peak periods.

Allowing customers to control their usage patterns and to implement usage decisions, though, only deals with one aspect of power management. Sometimes the voluntary behavior of customers is not enough to avert problems such as excessive power demands. Ideally, a customer system would allow not only the user, but also the power supplier (i.e., utility company)or a service provider to have at least some degree of control over the loads connected to the power mains.

These interests have led to a variety of systems for allowing control functions such as “load shedding” (that is, selectively turning off devices, or loads) to be performed. For example, numerous home and building automation systems are known in the art. Many of these automation systems allow the user to schedule appliances to turn on, or to be operated, only at defined times. The present invention recognizes that few, if any, allow the power utility and the customer to remove loads from the electrical grid (or “utility system”) selectively or activate/deactivate appliances.

Therefore, it would be advantageous to have an improved method and apparatus to allow the utility, service provider, customer appliances or the customer electrical network to negotiate power supply needs with the utility on a class of service basis.

The ability for a customer and power company to control the electric power provided to the customer is known in the art. For instance, U.S. Pat. No. 5,572,438 to Ehlers et al. discloses an energy management automation system which includes a local area network database connected via control modules attached to a customer's circuit breaker box which provides means to disconnect an electrical load from the electrical main upon command or upon the occurrence of a power outage. Ehlers discloses electric current control modules which measure the load current and power used by the customer, which then transmit the data to a local area network. However, the present invention recognizes that no other features or controls are disclosed which provide for an electrical power customer or service provider to electronically negotiate with the utility power supplier for the supply of electrical power to individual outlets or appliances on the customer electrical network on a class of service or level of importance basis.

As may occur from a natural event, such as a storm, or the development of an excessive load, as may occur from an extreme weather situation, power degradation or outage presents a problem to electric utility companies. The instant power is restored or a large disconnected load is brought back on line, the energization of all the loads connected to the power grid may cause a current surge which can induce a large transient voltage spike due to load, line and transformer inductances. In turn, this can destabilize the power grid and cause damage to equipment connected to the power mains. Safety features may cause substations and generators to be switched off-line, to protect equipment from damage, at the very moment the substations and generators are needed to be on-line to meet load demands.

A utility company, a governmental entity, or a service provider might also wish to distribute power selectively to certain types of loads, or withhold power from certain types of loads, during problem situations. For example, during natural disasters and peak load times such as excessively hot summer days, it may be a valid power system management plan to ration power delivered to specific customers, or to specific appliance types, such as water heaters, pool pumps, air conditioners, or low priority (i.e., nonessential) loads in general, in order to prevent generator or distribution system problems. Employing this approach, it may also be possible for the utility company to avoid the expense of building substation or generation capacity solely to be able to withstand such extreme situations.

A need exists for an automated system for monitoring and controlling energy (power) consumed by specific loads operated by the customer, which provides for the utility and customer to monitor and control power consumption on a class of service based on a monetary rate incentive or level of importance. The present invention recognizes the limitations existing in the prior art and that a need exists for improved method of economically controlling the peak power supply and consumption by industry and individual customers. Likewise, the present invention recognizes the need associated with the efficient provision of power which is negotiated automatically with very little, if any, involvement by the human consumer.

### SUMMARY OF THE INVENTION

The present invention provides a system and method for a utility or service provider to provide electricity to customers via a class of service. The system and method provide a mechanism by which electricity is supplied to a customer electrical system via prioritized classes of importance wherein the point of utilization communicates with the electrical power supply network and relays information for the utility or service provider to determine whether or not power needs to be supplied to a specific outlet or appliance during various electrical demand periods.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a data processing system that may be implemented as a server depicted in accordance with a preferred embodiment of the present invention;

FIG. 3 depicts a block diagram illustrating a data processing system in which the present invention may be implemented;

FIG. 4 depicts a block diagram illustrating a data processing system in which the customer system of the present invention may be implemented;

FIG. 5 is a block diagram of a table of classes depicted in accordance with a preferred embodiment of the present invention;

FIG. 6 is a flowchart depicting one embodiment of the present invention wherein the utility server queries the customer computer via the internet, a local intranet, or the World Wide Web, to determine the class of service requirements for a defined power consuming region during electrical demand or a particular period of time;

FIG. 7 is a flowchart of a process used for dynamically reassigning a class of service depicted in accordance with a preferred embodiment of the present invention;

FIG. 8 is a flowchart of a process used for managing power consumption depicted in accordance with a preferred embodiment of the present invention;

FIG. 9 is a flowchart of a process used for changing a class of service for a customer depicted in accordance with a preferred embodiment of the present invention;

FIG. 10 is a flowchart of a process used for managing power usage in a customer location depicted in accordance with a preferred embodiment of the present invention;

FIG. 11 is a flowchart of a process used for utility management of the power supply to the customer system at a customer location depicted in accordance with a preferred embodiment of the present invention;

FIG. 12 is a flowchart of a process used for a customer system managing power usage at a customer location depicted in accordance with a preferred embodiment of the present invention;

FIG. 13 is a pictorial representation of an embodiment of a distributed data processing system including a service provider in which the present invention may be implemented;

FIG. 14 is a flowchart of a process used for utility management of the power supply to the customer system at a customer location via broadcast by the utility service depicted in accordance with a preferred embodiment of the present invention; and, FIG. 15 is a flowchart of a process used for management of the power supply to the customer system at a customer household by the utility service and a service provider depicted in accordance with a preferred embodiment of the present invention.

### DETAILED DESCRIPTION OF THE PREFERRED EMBODIMENT

The system of the present invention may be implemented with a network which contains a “customer system” including a customer computer associated with the customer's electrical network and connected via the world wide web network, an intranet or other connection system to a second computer or computer server affiliated with the electric utility. The customer system also includes, but is not limited to, the customer's electrical network, power outlets, phone jacks, CATV outlets and appliances connected thereto.

The entire system and method is governed by computer software and protocols which enable communication between the computer located at the utility service provider and each individual customer system. The power requirements of the customer system are transmitted to the electrical utility service provider which fall within predetermined classes of utility service, which are defined levels of utility service, whereby the electrical utility provider offers electricity at various rates, at various times, or during peak or low power demand levels which are transmitted to the customer system via a network, as documented by a service level agreement entered into between the utility and customer.

Different classes of utility service may have different levels of permitted power consumption, which may be defined as the constraints on allowable power consumption (e.g. unlimited consumption allowed, no new consumption allowed, limited consumption allowed) within a region of the electrical power grid. A region may be defined as an independently addressable entity that can accept commands over a network and modify the permitted utility service consumption. A region may be associated with one class of utility service. Addressable also refers to both power control granularity and to communication over the network. The granularity of obedience may be dependent on the capabilities of the region (e.g. some regions may only be turned on or turned off, some regions may have restricted power modes, some regions may control their power by to fractions of a milliwatt). A regional policy may be defined as a function of price or other incentive to change or accept a different class of utility service.

In one embodiment of the present invention, the customer system is made up of “smart” electrical outlets and appliances which have assigned unique “addresses”. The utility queries the customer system which responds to the query by identifying each specific address as requiring a specific class of service requiring a certain level of power supply. During peak electrical demand periods, the system and method allows the customer system to communicate with the utility provider and negotiate which, if any, of the customer system outlets or appliances can be deactivated or powered down to a lower level of consumption so as to conserve power and reduce the amount of electrical load demand on the utility electric grid. This results in the conservation of power-generation resources, the amount of electrical costs incurred by the customer, and more efficient usage of the electrical power supplied to the entire utility system.

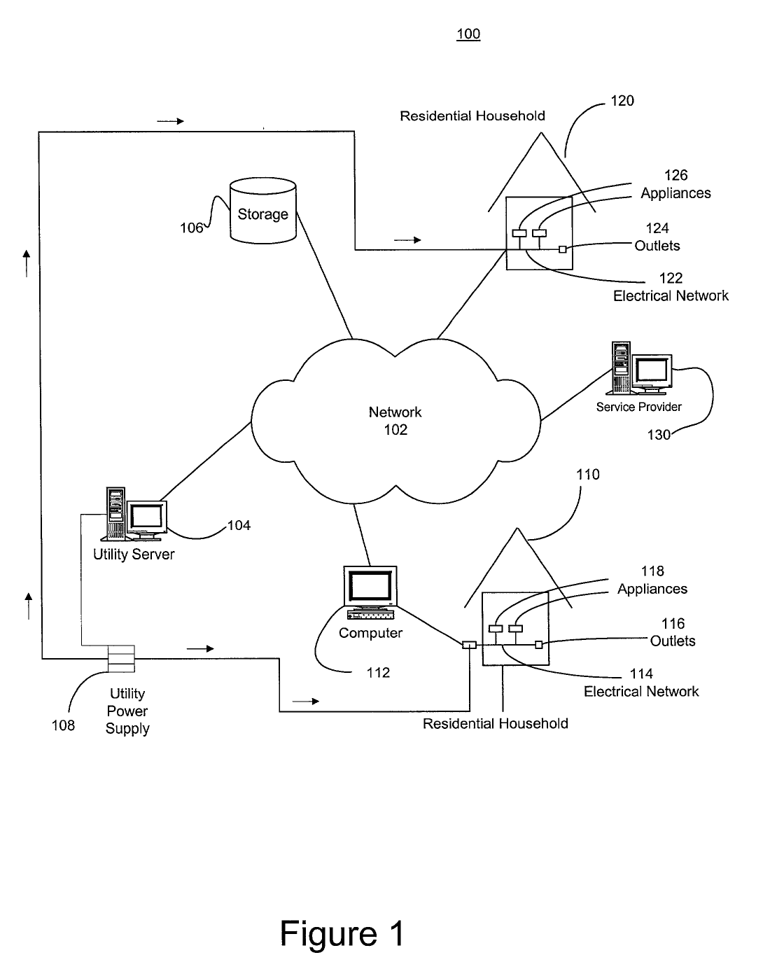

With reference now to the figures, FIG. 1 depicts a representation of distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 includes connections such as wire, fiber optic cables, and telephone connections. In the depicted example, a utility server 104 is connected to network 102 along with storage in it 106. Utility server 104 provides data, such as data files, operating systems, images, and applications to utility power supply 108. Utility power supply 108 is a client to server 104. Service provider 130 is a third party vendor which is connected to network 102 and communicates with utility server 104 and computer 112. Service provider 130 may provide data files, operating systems, images and applications to utility server 104 and customer 112. Distributed data processing system 100 may include additional servers, clients, and other devices not shown.

In the depicted example, the serving area of a utility is regionalized. Each region is associated with a class of service. Each region is independently addressable by the electrical utility, where addressable means “able to be granted service or have service withdrawn independently of the power level elsewhere within the region”, as well as identified with a unique identifier, such as an IP address using the IPv6 protocol. Regions need not be geographically large, and more importantly, regions may not be geographically disparate, but may overlap significantly. For example, one size for a region is a single outlet (e.g. power socket or telephone jack) or appliance. Further, when a region is associated with a single customer (for example, an enterprise, or a home), the provisioning of service may be based on interactive exchange with the customer system. For example, a utility server 104 may communicate via network 102 with outlets 124 and appliances 126, which receive power from electrical network 122, on an interactive basis to determine the level of service required by or provided to each outlet 124 and appliance 126.

The embodiment depicted in FIG. 1 shows a utility server 104 with off-site storage medium 106 connected to a utility power supply 108. Utility power supply 108 provides power to the utility system which includes residential households 110,120. Utility server 104 is connected to a region defined as a consumer residential household 110 through customer computer 112 and network 102. In an alternative embodiment, utility server 104 can be connected to a region defined as consumer residential household 120 via network 102 which is connected to the customer system comprised of electrical network 122, outlets 124 and appliances 126. Computer 112 is connected to the customer household electrical network 114 within residential household 110. Electrical network 114 includes addressable outlets 116 and appliances 118 plugged in thereto. Electrical network 114 is connected to power supply 108. Electrical network 114 may also include a local area network to allow communications between devices capable of providing information on power usage within electrical network 114. Computer 112 allows the transmission and receipt of data including power consumption data and operating instructions from either utility server 104 or service provider 130 via network 102. In this example, a residential household is illustrated as a customer location. The present invention may be applied to numerous other types of customers, such as, for example, a manufacturing facility, a business store, a hospital, or an office building.

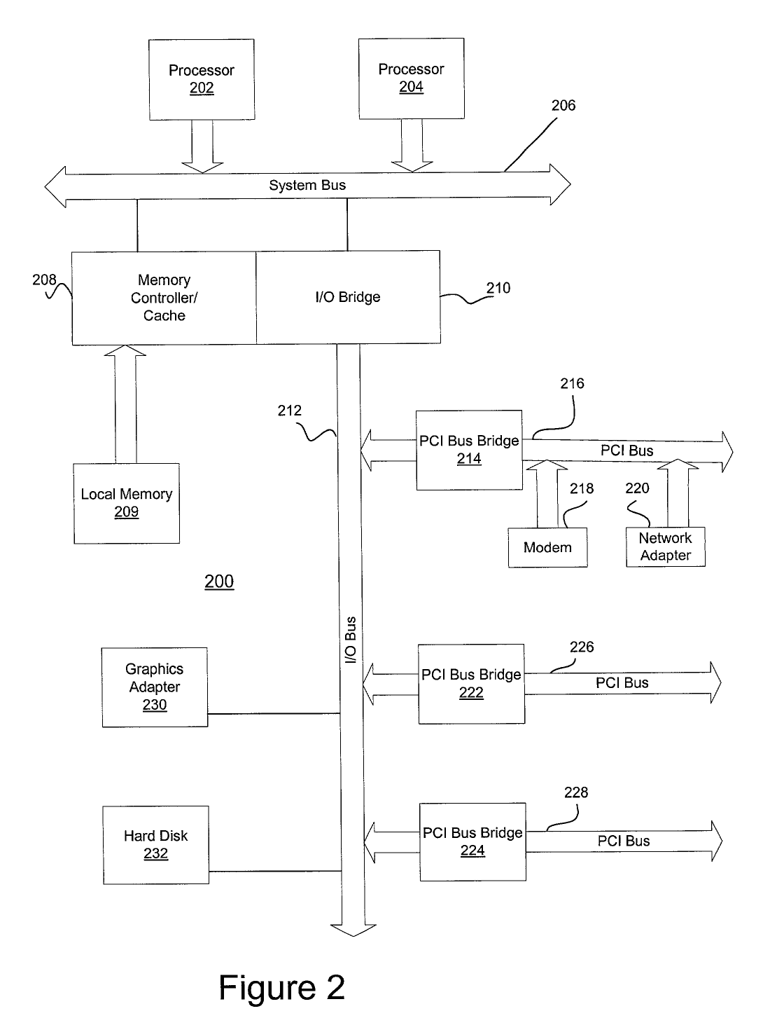

Referring to FIG. 2, a block diagram of a data processing system that may be implemented as a server, such as utility server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

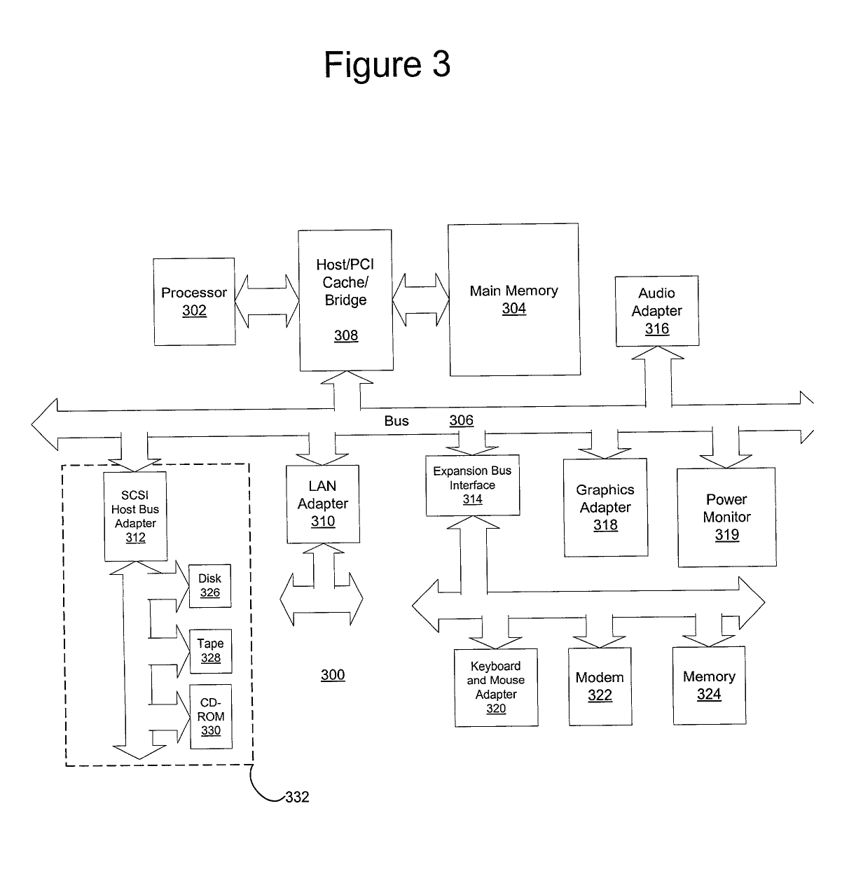

With reference now to FIG. 3, a block diagram illustrating a data processing system is depicted in which the present invention may be implemented. Data processing system 300 is an example of a computer, such as computer 112 in FIG. 1. Further, data processing system 300 may be modified to include fewer components for use in devices consuming power at a customer location, such as a household appliance. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and power monitor adapter 319 are connected to PCI local bus 306 by add-in boards inserted into expansion slots. In this example, power monitor adapter 319 is connected to an electrical network, such as electrical network 114 in FIG. 1.

Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface.

The depicted example in FIG. 3 and above-described examples are not meant to imply architectural limitations. For example, data processing system 300 also may be a notebook computer or a device in a black box connected to a power supply system at a customer location.

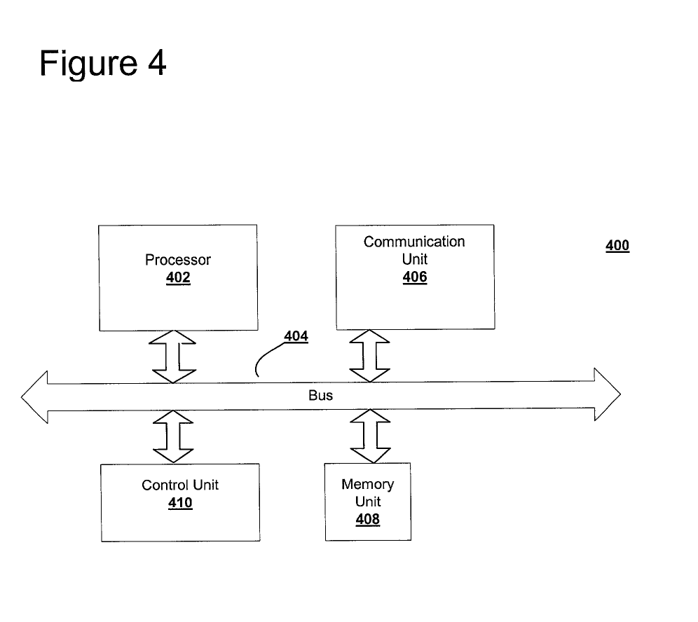

FIG. 4 depicts one embodiment of a control mechanism 400 for a customer system comprising a “smart” appliance 118 or “smart” outlet 116 connected to electrical network 114. Control mechanism 400 may include a processor unit 402 connected to system bus 404. A communication unit 404 for sending and receiving messages and instructions is connected to system bus by 404, along with a memory unit 408 for data and address storage. Likewise, a control unit 410 is connected to system bus 404 which performs command instructions. In an alternative embodiment of the present invention, control mechanism 400 may be retrofitted to existing outlets and appliances as a black box attachment as opposed to internal placement in the existing outlet 116 or appliance 118.

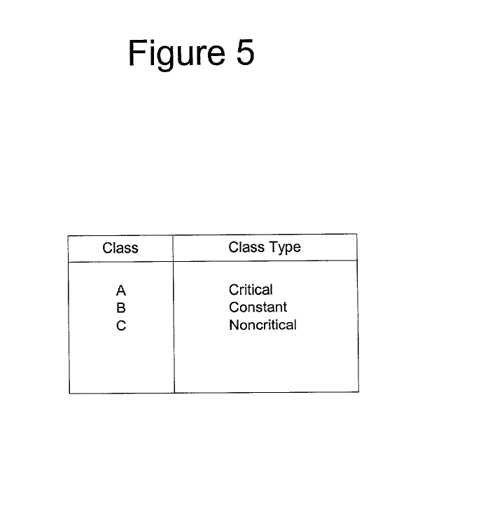

Turning next to FIG. 5, a block diagram of a table of classes is depicted in accordance with a preferred embodiment of the present invention. Table 500 includes a class and a class type used in managing power consumption and negotiating rates.

Customer systems are allocated to predefined classes of service (e.g. Class A,B,C,D, etc.) The assignment of class of service to a customer system can be done by the customer system manufacturer, by the merchant selling the device, or by the end user, or by others (e.g. power optimization service). The assignment of class of service can be implemented using any number of well known methods of placing and storing data in an intelligent device (e.g. read only memory, switches or settings, Bluetooth connection, Internet connection, etc.). Classes of service may also be defined by the importance of service supplied to certain customer systems or processes utilized by the customer. That is, in the case of a power utility, one class of service, class A, may reflect appliances or uses which require constant, uninterrupted power (e.g. life support ventilator). In this example, class A is a critical class type. Class B service is a constant usage class type. This class may consist of appliances or usage, which desire 24 hour, seven days a week power supply (such as telephone, security alarm), but which can sustain brief interruptions without terminal failure or damage. Class C service is a non-critical class type and may be assigned to non-critical appliances or usage which can sustain multi-hour interruption (e.g. radio, television, blender).

Pricing terms can vary for different classes of service. Class A may have a constant higher per watt charge. Class B may have a variable charge based on the amount of power demand present on the grid. Class C may have an auctioned price. For those regions associated with a single customer, the terms and conditions may include auction pricing, and may include dynamic reassignment of a different class of service based on the outcome of the auction.

Classes of service can also be predefined or exist wherein the customer and utility service provider enter into an agreement where different amounts of electricity are supplied during various times of the day which are related to varying electrical price rates or varying electrical demand. Also, regions or devices accessing power can participate in an interactive exchange with the utility power provider to establish which class of service they require or are willing to accept. In one embodiment there is a class of devices all of whom can take direction from the utility service provider, from other service providers, or from the end user. Such directions can be given via communications networks (wireline, wireless, over electrical cable), through the Internet or other protocols e.g. broadcast, multicast, or direct communication), or through manual selection (e.g. a switch on the side of the appliance with multiple settings, or a keypad directly attached to the appliance).

Note that in some embodiments, appliance devices may receive communications but be unable to send messages. In these embodiments, the utility or service provider makes assumptions that the commands are being executed by a statistically significant number of power consuming devices. Feedback is obtained by the utility server in the form of changes to the amount of power being consumed from the grid.

For example, in a preferred embodiment, the customer system appliances can accept commands of the following nature:

I. All appliances of class X, if already on, turn off and stay off until further notice; or,

II. All devices of class X, if already on, you can stay on. If not on, do not turn on until further notice; or,

III. All device of class X you are free to turn on; or,

IV. All devices of class X are prohibited form being on.

In alternative embodiments, these commands can be further ramified by stating a time interval during which they are effective, (e.g. turn off and stay off for 15 minutes). Further some devices can have a power saver or restricted consumption mode wherein they accept commands to restrict usage (e.g., class X devices go to predefined power mode). The power modes may be defined by the devices themselves in a manner appropriate to the device (e.g. a steam iron may draw power only during alternate minutes of use), or may be dictated by the command (e.g., the command may include a maximum power level, so that appliances step down the wattage they draw, for instance, an electric shaver may operate on a lower power level).

In an alternate embodiment, the customer system devices may request a power allocation before beginning to draw significant power. The service provider may evaluate such requests based on current usage, appliance requirements/priority, status of account payment, and current pricing. If the service provider determines that the request can be granted, either power is transmitted to the customer system appliance (assuming a single appliance region), or the appliance is given instructions to begin drawing power. This request structure allows the service provider to measure desired usage in addition to measuring actual usage.

There are multiple scenarios for the use of these commands. In one embodiment, the commands are used by the utility to manage peak power consumption during peak usage periods. For example, on hot summer days, air conditioner usage may drive the desired peak consumption above what the utility can supply. Assuming that all air conditioners are class D, the utility might systematically, direct ten percent of the air conditioners to shut down. This ten percent could be rotated across its customers. In this manner, the peak usage is controlled, while at the same time the effect on the customers is minimized. For example, clocks would not have to be reset, videotape recorders would not “blink 12” and suffer recording interruptions. Likewise, essential devices, such as respirators, would continue normal operation.

In another embodiment, the utility affects power consumption by changing the electricity price rates. The utility communicates, via broadcast, narrowcast, or placing in a server for appliances to “pull”, a change in electricity rates. The change in rate might take the form of a change in flat rate for all energy consumed. The change in rate might also take the form of a step function for power consumed. For example, the utility may change 10 cents per kilowatt hour for the first three kilowatts and 25 cents per kilowatt hour for energy consumed at a power rate over three kilowatts. The rates and rate changes may be unilaterally set by the utility, may be negotiated between the customer and the utility, may be set by regulation or set other means (e.g. marketplace for electrical power).

In response to the change in electrical rates it is expected that the customer will change his or her power consumption in a manner related to the electrical rate change. In one embodiment, a service provider working on behalf of the customer will send appropriate commands to the customer's devices. The service provider may or may not have access to the measurement of the total power consumed by the customer. This measurement of total power consumed could be supplied by the electric meter communicating with the service provider. However, it is expected that such measurement will on be uniformly available. In the case where it is available, one might expect the service provider to give commands to power down/power up devices in a priority order or based on algorithm supplied by the customer. This is also the case when such consumption data is not available. However, we expect the customer to achieve a better balance between the price he or she is willing to pay and the service he or she receives when such data is available. Such a service provider might be an independent business entity, a service provided by the utility, or such service might be undertaken by the customer himself. Based on the aggregate of actual power consumption or desired power consumption, the service provider may choose to purchase additional power on the open market. Likewise, in light of these consumption metrics, the service provider can also set electricity prices accordingly.

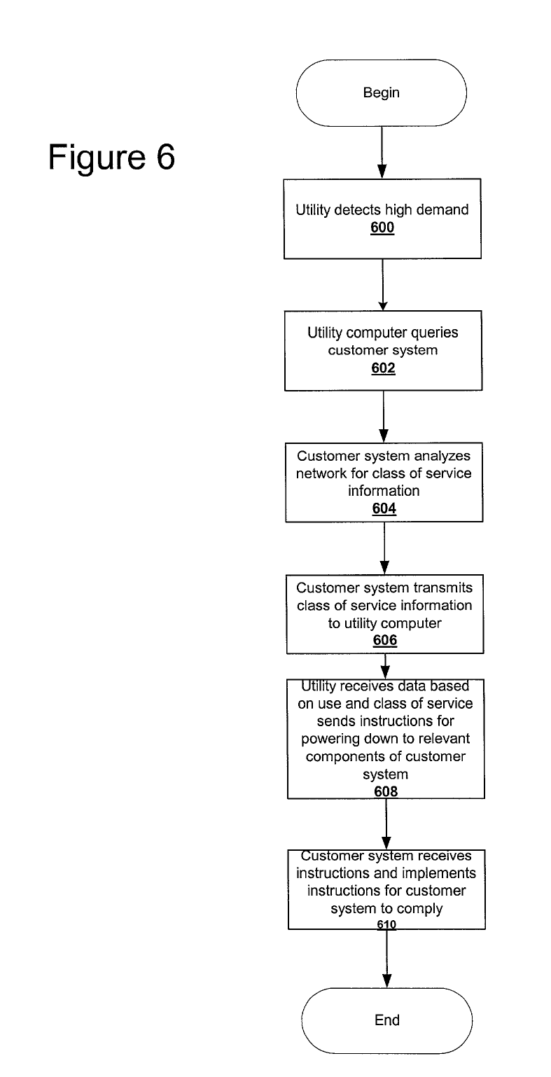

Turning next to FIG. 6, a flowchart of a process used for monitoring and managing power usage using different classes of service is depicted in accordance with a preferred embodiment of the present invention.

The utility server detects an increased electrical power demand on the electrical grid (Step 600). The utility server queries the system for the class of service required by each outlet or appliance (Step 602). The customer system analyzes the electrical network and appliances connected thereto, (Step 604). The customer system transmits class of service information to the utility server (Step 606). The utility server then issues instructions to the customer system to activate, deactivate, decrease or increase the power demand to the outlets or appliances connected to the customer system (Step 608). The customer system receives instructions from the utility to activate, deactivate, decrease or increase the power demand to each specified outlet or appliance and complies with same(Step 610).

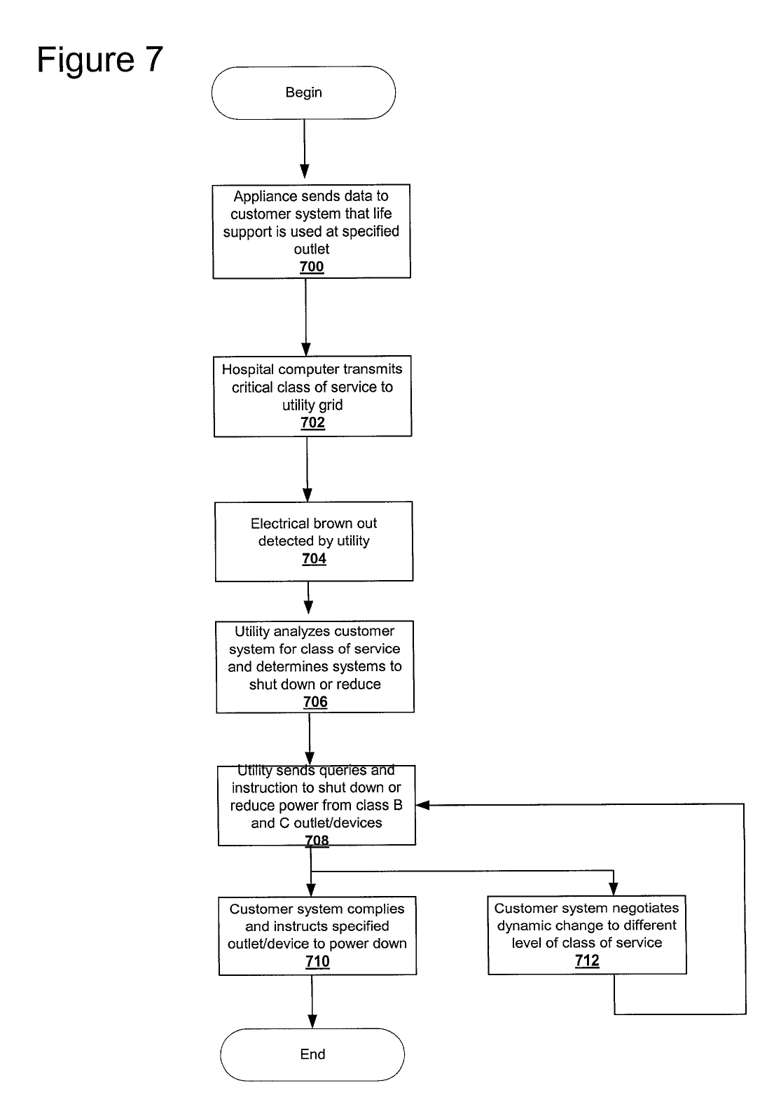

With respect to FIG. 7, a flowchart of a process used for dynamically reassigning a class of service is depicted. The detection of power degradation over the entire utility system would permit the electrical utility to exercise control over the power supplied to customers during periods of high electrical consumption or low power generation. Having established membership in a region associated with a class of service permitting interruption, one embodiment of the invention provides for the customer system to be controlled directly by the electric utility or utility server which enables the utility service to control power consumption at the customer level by issuing instructions over a network which lower the amount of electrical power supplied to the devices in the region.

For example, “smart” appliances located at an acute care hospital are plugged into addressable outlets and emit identification signals to the on-site network computer as to their required class of electrical service (Step 700). Class of service information is transmitted to the utility server (Step 702). The utility server analyzes the electrical power grid detects an increased electrical demand which could result in demand which is in excess of current supply, what is known as a “brownout” (Step 704). The utility server analyzes the class of service data received from the customer system to determine the classes of service required by each appliance and determines which appliances may have their power supply decreased or removed so as to satisfy the increased electrical demand in other areas of the electrical grid (Step 706). The utility server sends instructions to the customer system to reduce or terminate the power supply to specified outlets or appliances that do not require constant, uninterrupted power supply (Step 708). The customer system either complies with the instruction to power down or terminate electrical supply to indicated outlets or appliances (step 710) or may negotiate with each outlet, appliance or the utility server to accept a different class (e.g. Class B or Class C) of electrical service at a different cost rate or time period (Step 712).

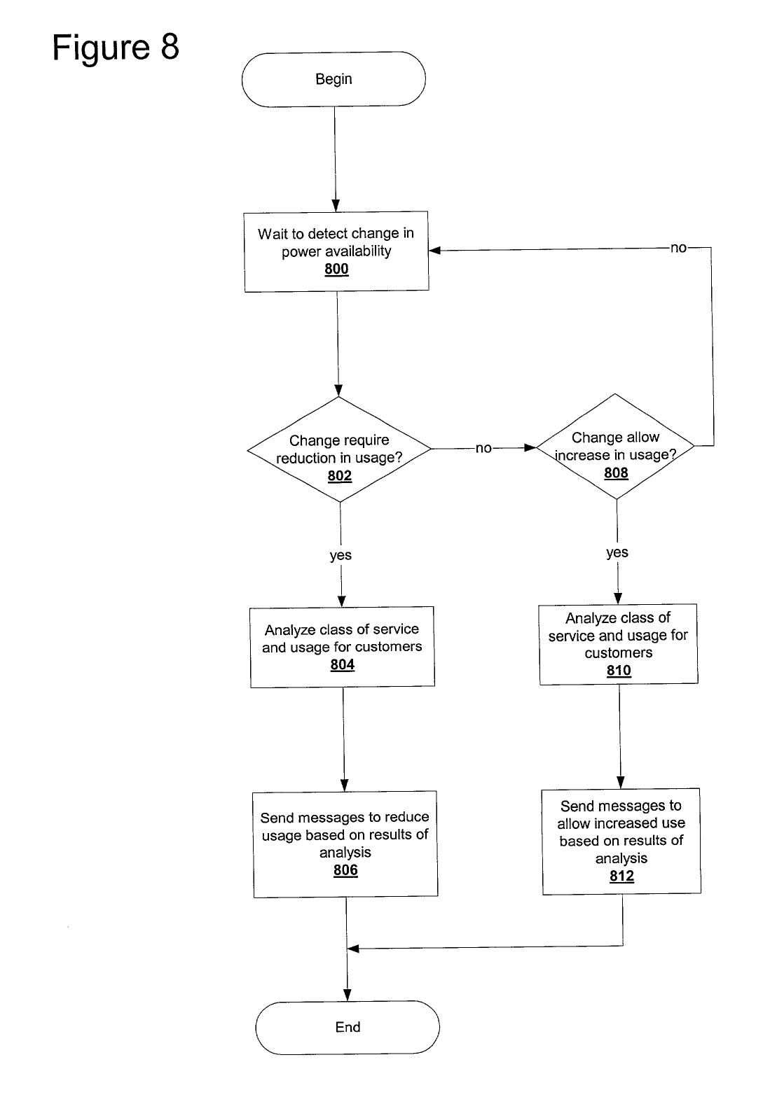

Turning next to FIG. 8, a flowchart of a process used for managing power consumption is depicted in accordance with a preferred embodiment of the present invention. The process illustrated in FIG. 8 is an example of steps that may be implemented as a set of computer instructions in a utility server, such as utility server 104 in FIG. 1.

The process begins by waiting to detect a change in power availability (Step 800). A change in power availability may be detected through a connection to a utility power supply, such as utility power supply 108 in FIG. 1. An increase or decrease in power availability may be detected (Step 800). Such increase or decrease in available power may be the result of the utility selling off excess power to other competing utility suppliers. Next, a determination is made as to whether the change requires a reduction in power usage (Step 802). If the changes do require a reduction in power usage, the class of service and power usage for customers is analyzed (Step 804). The power usage may be monitored based on data received from customers through computers at the customer location. Then, messages are sent to selected customers to reduce the usage based on the results of the analysis (Step 806) with the process terminating thereafter. These messages are sent to computers for the selected customers, such as computer 112 in FIG. 1.

With reference again to step 802, if the change does not require a reduction in usage, a determination is made as to whether the change allows an increase in usage (Step 808). If the change does not allow an increase in usage, the process returns to step 800. If the change does allow an increase in usage, the class of service for customers is analyzed (Step 810). Then, messages are sent to allow increased usage based on the results (Step 812) with the process terminating thereafter.

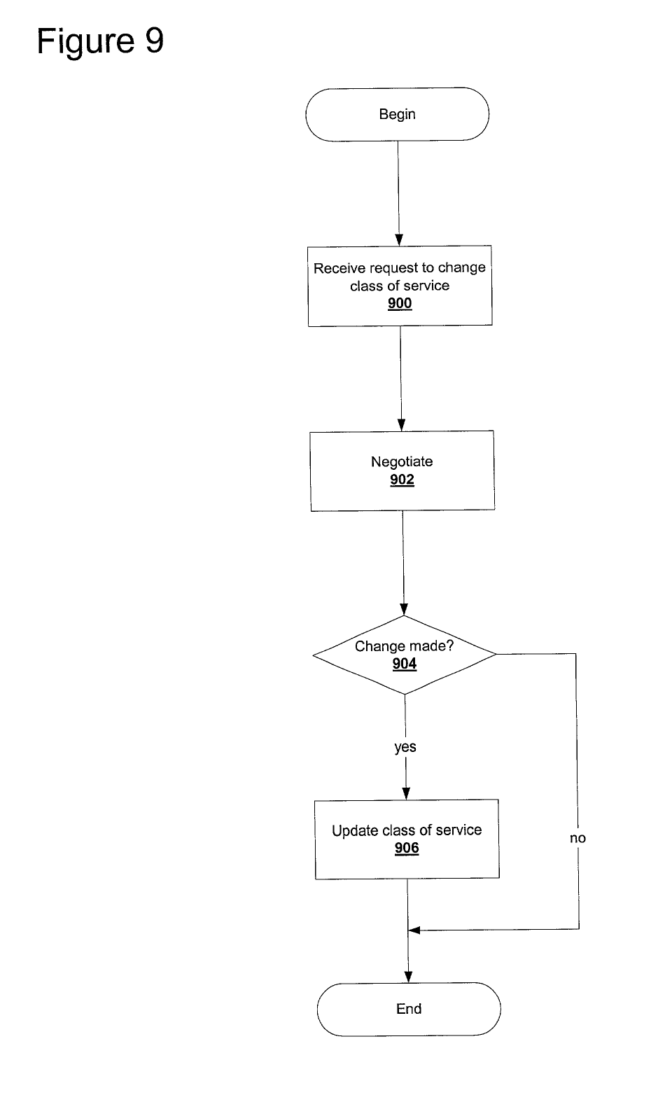

Turning next to FIG. 9, a flowchart of a process used for changing a class of service for a customer is depicted in accordance with a preferred embodiment of the present invention.

The process begins by receiving a request to change the class of service (Step 900). Next, the class of service is negotiated (Step 902). The negotiation may involve factors such as changes in rates and power availability for the different classes of service. For example, the request may be to change the class of service to a class A service from a class B service. But whether the negotiations result in a change depends on the rate for the class A service. If the customer or customer is unwilling to pay the higher rate, then the class of service does not change. These negotiations take place automatically in these examples through pre-authorized limits set by the customer. Alternatively, the customer may select or authorize a rate during the process itself.

Then, a determination is made as to whether a change was made (Step 904). If a change was made, the class of service is updated (Step 906) with the process terminating thereafter. The update is made in a database, such as one located in storage 106 in FIG. 1. With reference again to step 904, if a change was not made, the process terminates.

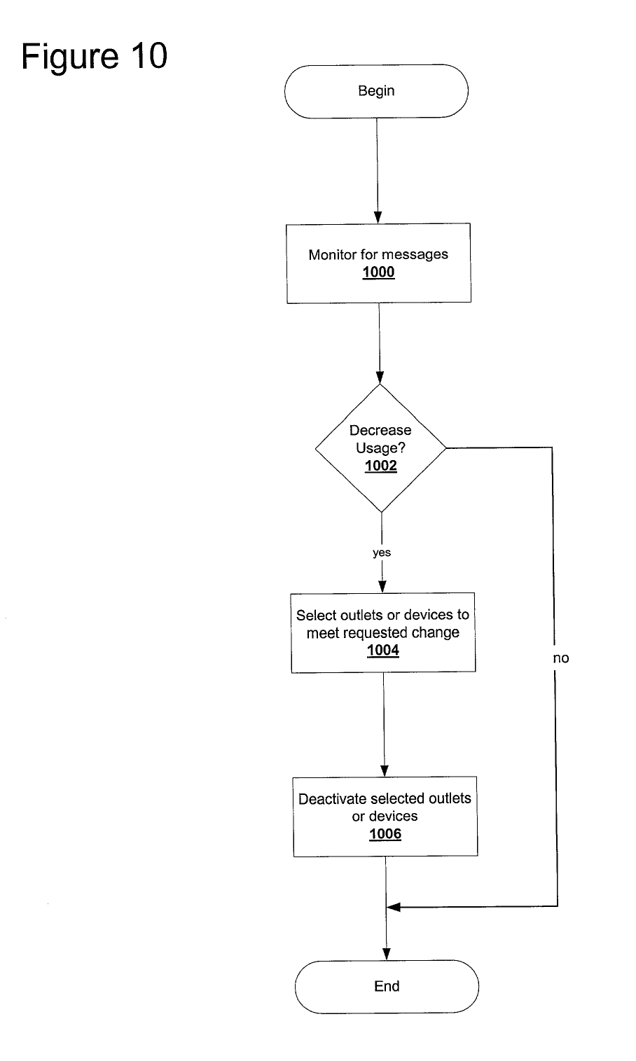

Turning next to FIG. 10, a flowchart of a process used for managing power usage in a customer location is depicted in accordance with a preferred embodiment of the present invention. The process in FIG. 10 may be implemented as a set of computer instructions in a computer, such as computer 112 in FIG. 1, to manage power usage at a customer location.

The process begins by monitoring for messages (Step 1000). Next, a determination is made as to whether a received message requires a decrease in power usage (Step 1002). If a decrease in power usage is required, outlets or devices are selected to meet the requested change (Step 1004). Then, the selected outlets or devices are deactivated (Step 1006) with the process terminating thereafter. With reference again to Step 1002, if a decrease in usage is not required, the process terminates. A similar process may be used to monitor for messages that allow for an increase in power usage at a customer location.

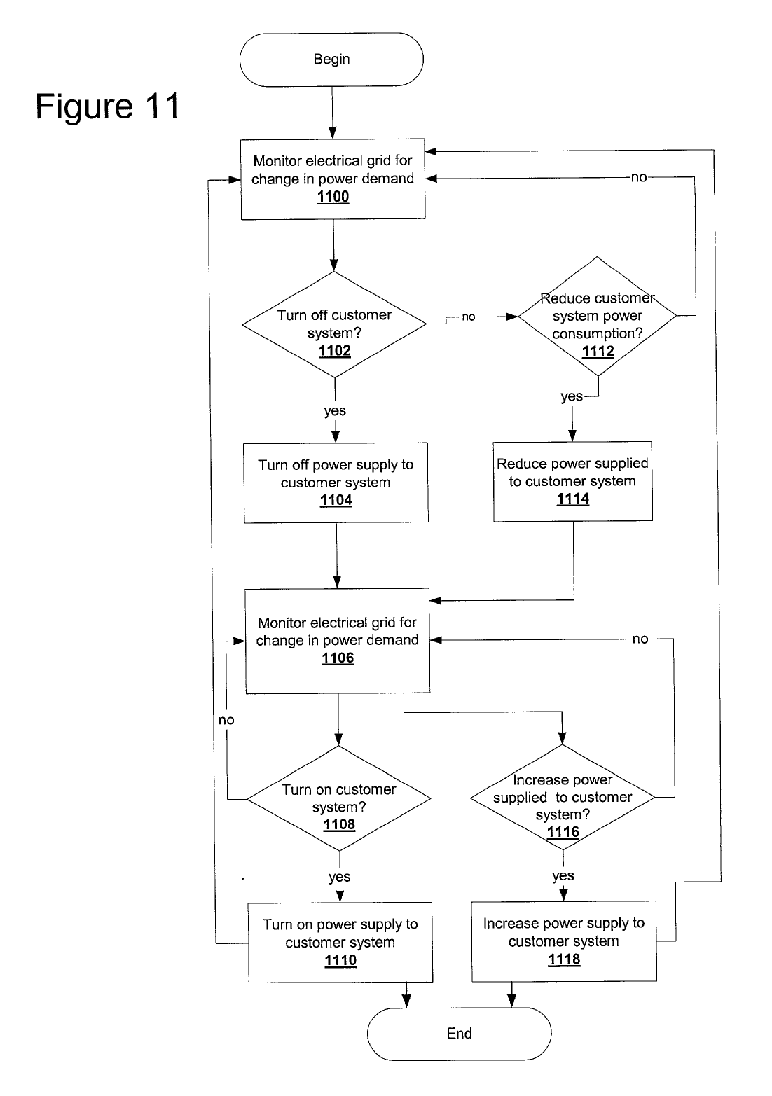

FIG. 11 represents a flowchart of one embodiment of the present invention showing a process used by the utility service provider for changing a class of service for a customer. The utility service provider monitors the electrical grid for an increase or decrease in electrical demand (Step 1100). For example, an increase in electrical demand is detected and the utility queries the customer system and determines whether or not to turn off power to the customer system to reduce the power demand to customer systems which will accept a different class of service (Step 1102). If the customer system does not require a class of service consisting of constant power supply, power to the customer system is turned off (Step 1104). If the customer system requires a class of service consisting of uninterrupted power supply, a second query is made which asks the customer system if the power supply may be reduced to a lower level (Step 1112). If the customer system requires full power, the utility continues to supply full power to the customer system and resumes monitoring the grid for changes in the electrical demand (Step 1100). If the customer system requires a class of service which can sustain a lower power supply, the utility lowers the amount of power supplied to the customer system (Step 1114).

After the necessary adjustments in the power supply to the customer system are made in response to the change in electrical demand on the electric grid, the utility continues monitoring the electrical grid for a change in power demand (Step 1106). Continuing with the example above, the utility service detects that there is a decrease in power demand on the electric grid and queries the customer system and determines whether or not to turn on power to the customer system (Step 1108) or to increase power to the customer system at the existing class of service before the increase in electrical demand (Step 1116). If the power to the customer system was previously turned off or reduced, the customer system's class of service may provide for the power to remain off or stay at reduced levels until another change in demand is detected by the utility service (Step 1106). Alternatively, the utility service reactivates the customer system (Step 1110) or increases the power supply to the customer system (Step 1118).

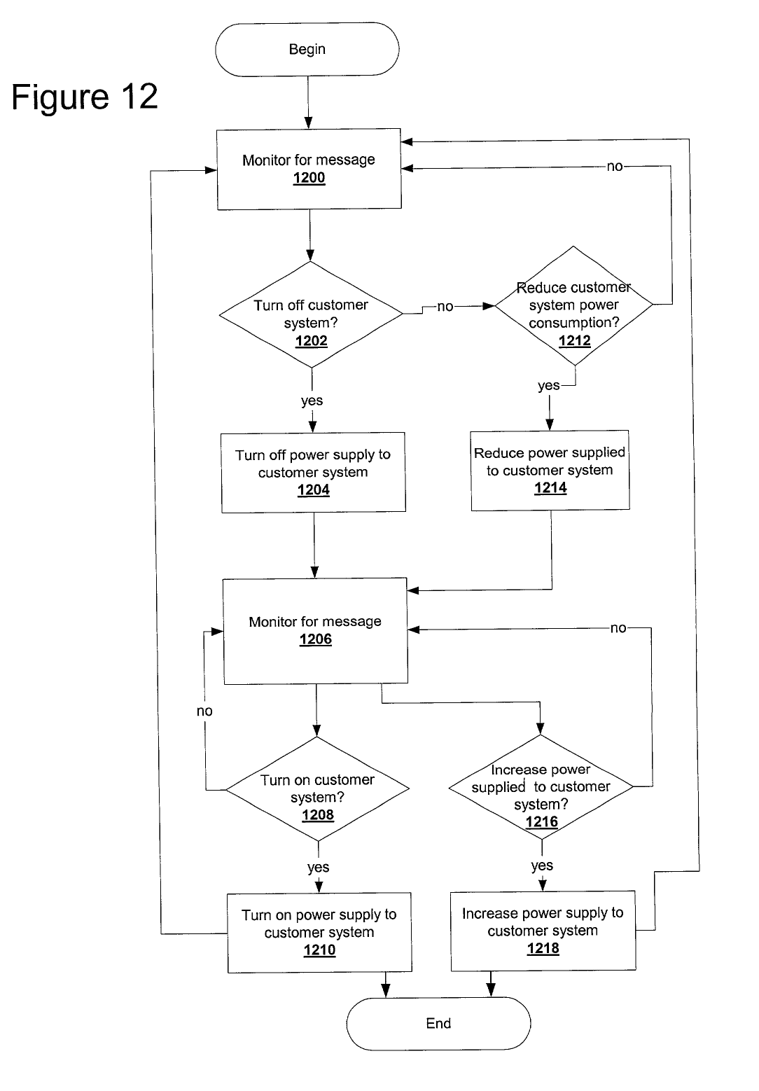

FIG. 12 represents a flowchart of one embodiment of the present invention showing a process whereby the customer system for controls negotiation of the class of service provided by the utility service. The customer system monitors the electrical grid or network for a message from the utility service (Step 1200). For example, a message indicating an increase in electrical demand is detected. The customer system queries the customer system and determines whether or not to turn off power to the customer system (Step 1202). If the customer system does not require a class of service consisting of constant power supply, the customer system turns off power to each identified system (Step 1204). If the customer system requires a class of service consisting of uninterrupted power supply, the customer system determines if the power supply may be reduced to a lower level (Step 1212). If the customer system requires full power, the utility continues to supply full power to the customer system and resumes monitoring the grid for changes in the electrical demand (Step 1200). If the customer system requires a class of service which can sustain a lower power supply, the customer system lowers the amount of power supplied to the customer system (Step 1214).

After the necessary adjustments in the power supply to the customer system are made, the customer system continues monitoring the electrical grid or network for a message indicating a change in power demand (Step 1206). If a decrease in power demand is detected, a message will be received by the customer system which queries the customer system and determines whether or not to turn on power to the customer system (Step 1208) or to increase power to the customer system at the existing class of service before the increase in electrical demand (Step 1216). If the power to the customer system was previously turned off or reduced, the customer system's class of service may provide for the power to remain off or stay at reduced levels until another message is received by the customer system (Step 1206). Alternatively, the customer system reactivates the customer system (Step 1210) or increases the power supply to the customer system (Step 1218).

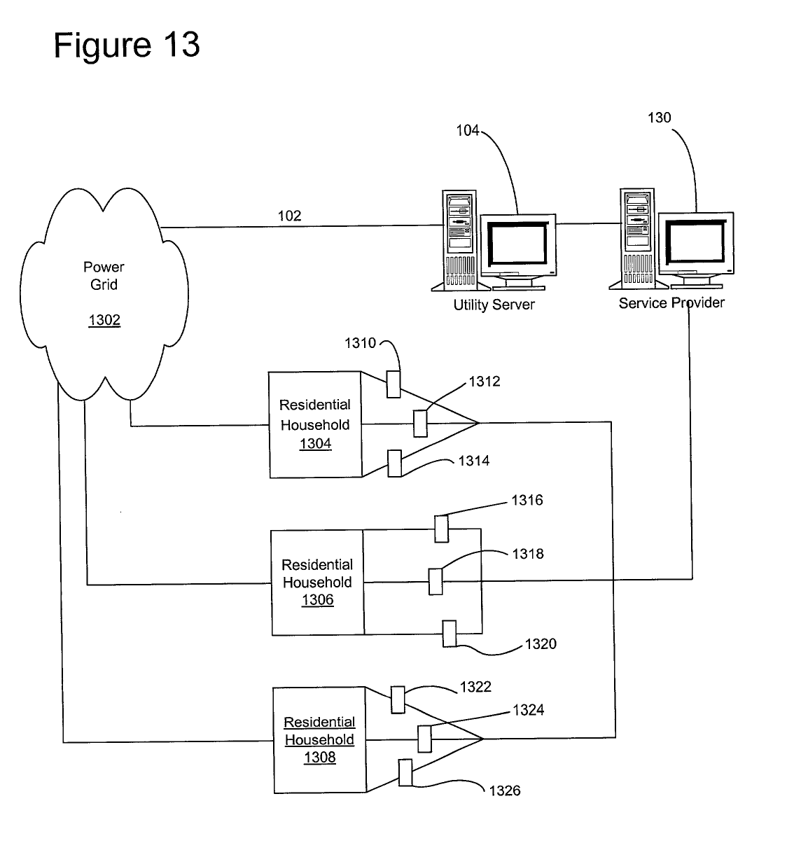

FIG. 13 depicts an alternative embodiment of the present invention wherein the electric power grid 1302 is shown providing service to customer residential households 1304, 1306 and 1308. Residential households 1304, 1306 and 1308 each contain a “smart” appliance with a class of service A, B, C, respectively. Residential household 1304 includes “smart” appliances 1310, 1312, and 1314. Residential household 1306 includes “smart” appliances 1316, 1318, and 1320. Residential household 1308 includes appliances 1322, 1324, and 1326. Utility server 104 has access to metrics regarding power availability and consumption of the power grid 1302. Utility server 104 makes decisions (e.g. algorithmically, via policy, via thresholds, via tables) on whether the consumption should be lowered or allowed to be raised, and whether this is done by in a directed fashion or via price incentives/disincentives. The service provider 130 receives instructions from or electricity pricing information from the utility server 104, and communicates with appliances 1310, 1312, 1314, 1316, 1318, 1320, 1322, 1324 and 1326 via network 102. Note that the function of service provider 130 may be bundled with the utility server 104, or may be provided by a separate business entity.

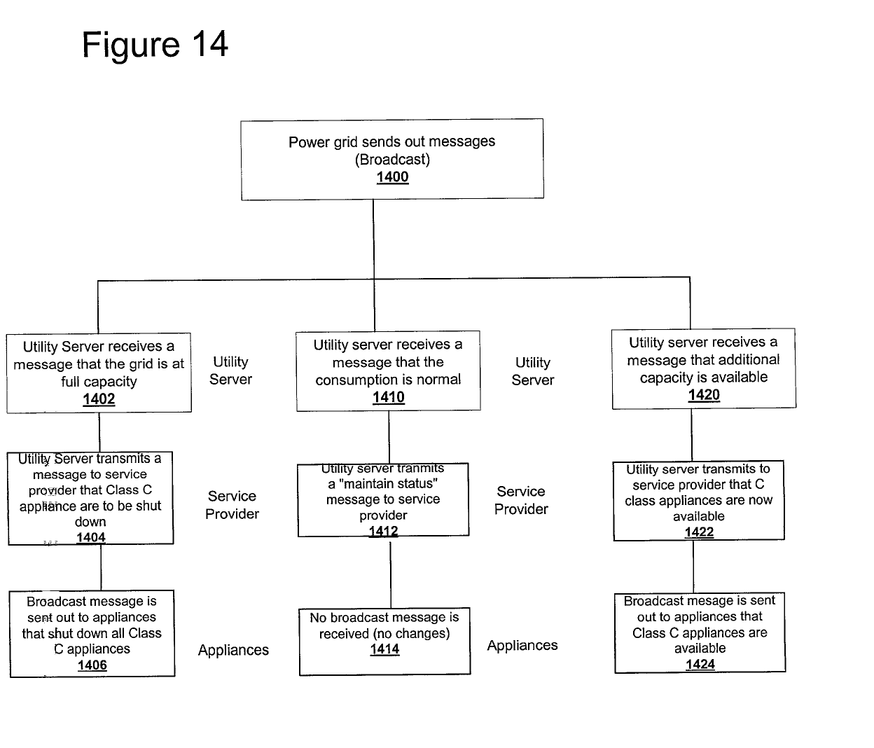

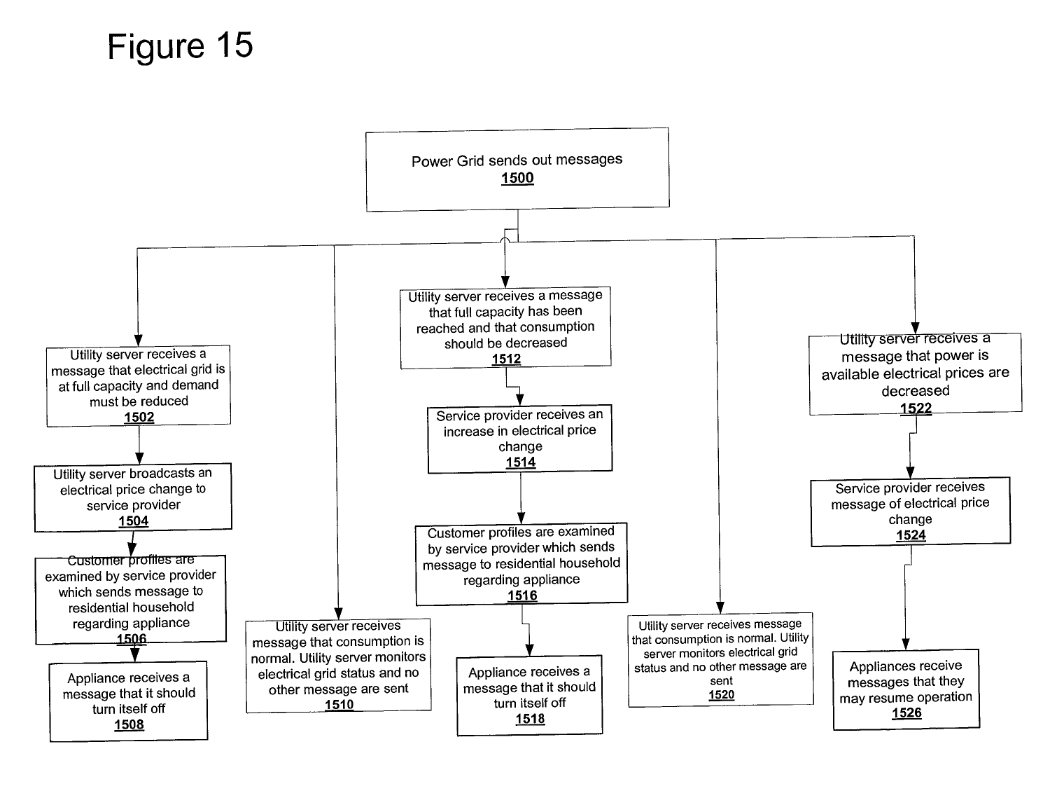

Turning to FIG. 14, the message flow between the power grid 1302, the utility server 104, the service provider 130, and the “smart” appliances 1310, 1312, 1314, 1316, 1318, 1320, 1322, 1324 and 1326 in residential households 1304, 1306 and 1308 is shown. In this embodiment, messages are sent via “broadcast” to all customer premises rather than addressed to individual appliances. The power grid broadcasts a message pertaining to a certain level of electrical demand or consumption (Step 1400). Different messages may be broadcast and, for the purposes of this example, three message flows are discussed. In the first scenario, the utility server receives a message that the electrical grid is at capacity (Step 1402). The utility server sends a message to the service provider indicating that class C appliances are to be shut down to conserve energy (Step 1404). The service provider relays this message and broadcasts to appliances that those of class C must shut down (Step 1406). Alternatively, the power grid broadcasts a message to the utility server that the current consumption is within normal limits (Step 1410). The utility server transmits a “maintain status” message to the service provider (Step 1412).

In a second scenario, the service provider does not broadcast any message to the appliances, as no changes are required (Step 1414).

In a third possible scenario, the power grid may transmit a message to the utility server that additional electricity is available (Step 1420). The utility server transmits a message to the service provider that class C appliances may now be operated (Step 1422). The service provider broadcasts messages to appliances that class C appliance operation is now permitted (Step 1424).

Referring to FIG. 15, the message flow between the power grid 1302, the utility server 104, the service provider 130, and the “smart” appliances 1310, 1312, 1314, 1316, 1318, 1320, 1322, 1324 and 1326 in residential households 1304, 1306 and 1308 is shown. In the depicted embodiment, messages are sent to specific appliances by the service provider and the appliances follow the messaged instructions. The power grid broadcasts a message pertaining to a certain level of electrical demand or consumption (Step 1500). Different messages may be broadcast and, for the purposes of this example, four message flows are discussed.

In the first scenario, the utility server receives a message from the power grid that it is at capacity, and that electricity demand must be reduced (Step 1502). The utility server broadcasts a price change to the service provider which states the electricity price is marked at 10 cents per kilowatt hour for the first two kilowatts, and 25 cents per kilowatt hour thereafter (Step 1504). The service provider examines previously constructed profiles of a customer's electricity policies and preferences, and sends a message to residential household that an indicated appliance should turn itself off (Step 1506). The indicated appliance receives the message to cease using power and turns off (Step 1508). Presumably, residential household has a strong desire to minimize spending on electricity and is willing to forgo the services of appliance at this point.

In a second scenario, the electrical grid merely sends a message that consumption is at normal limits to the utility server (e.g. a “SAFE” message) and the utility server then continues to monitor the status of the grid status, but sends no messages in response (Step 1510).

With regard to a third alternative scenario, the utility system indicates that it has again reached full operating capacity and that consumption should be decreased (Step 1512). The utility server raises electrical prices over and above the previously broadcast rates and sends a message to the service provider that the price has now risen to 10 cents per kilowatt hour for the first two kilowatts, and 35 cents per kilowatt hour thereafter (Step 1514). The service provider reviews customer electrical profiles and preferences, and based on the customer profile information, the service provider sends a message to residential household to instruct indicated appliance(s) to turn off (Step 1516). The indicated appliance receives the message and turns itself off (Step 1518). Thereafter, the utility server continues to monitor and maintain the electrical grid status, but no message is sent (Step 1520).

In a fourth scenario, the electrical grid indicates to the utility server that power is available and the utility server determines that prices can be lowered to provide an incentive for increasedent consumption and sends a pricing message to the service provider (Step 1520). The service provider receives a message that electrical power is 10 cents per kilowatt hour for the first two kilowatts, and continues to be available at 10 cents per kilowatt hour thereafter (Step 1522). The service provider sends a message to residential household that indicated appliance(s) may resume operation (Step 1524). Thereafter, the utility server continues to monitor and maintain the electrical grid status for further messages.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing a utility service, the method comprising the steps of:
analyzing relationship information representing a relationship of availability of the utility service and consumption of the utility service; and,
sending a message over a data network to at least one region of a utility service network to thereby modify utility service consumption based on the analysis of the relationship information.

2. The method of claim 1, wherein the message instructs at least one region permitting increased power consumption.

3. The method of claim 1, wherein the message instructs at least one region permitting decreased power consumption.

4. The apparatus of claim 1, wherein the message modifies permitted power consumption for aggregated regions.

5. The method of claim 1, wherein the data network is the Internet.

6. The method of claim 1, wherein the data network includes at least one of a wireless link and a Bluetooth connection.

7. The method of claim 1, wherein the data network contains at least one link sharing physical wiring with the utility service network.

8. The method of claim 1, wherein sending the message to at least one region includes broadcasting the message to multiple regions.

9. The method of claim 1, wherein sending the message to at least one region includes transmitting the message as a multicast message to multiple regions.

10. The method of claim 1, wherein each region of the class of service utility service network is classified into a class of service.

11. The method of claim 10, wherein sending the message includes broadcasting the message to regions in the utility service network having a given class of service.

12. The method of claim 10, wherein sending the message includes broadcasting the message to regions having a given class of service within a defined geographic area.

13. The method of claim 1, wherein the utility service is providing electricity.

14. The method of claim 1, wherein at least one region is one of a single power consuming device, a subset of a plurality of power consuming devices, a portion of the utility service network in a geographic region, and a consumption management service provider.

15. The method of claim 1, wherein the message instructs at least one region to modify at least one term or condition of sale.

16. The method of claim 15, wherein the term or condition of sale is at least one of price and a pricing method.

17. The method of claim 15, wherein modifying at least one term or condition of sale includes varying the price of the utility service based on a rate of consumption of the utility service.

18. The method of claim 1, further comprising:
analyzing historical data relating conditions of sale of the utility service to consumption levels of the utility service; and
generating the message based on the analysis of the relationship information and the analysis of the historical data.

19. A system for managing a utility service, comprising:
means for analyzing relationship information representing a relationship of availability of the utility service and consumption of the utility service; and
means for sending a message over a data network to at least one region of a utility service network to thereby modify utility service consumption based on the analysis of the relationship information.

20. The system of claim 19, wherein the message instructs at least one region granting permission for increased power consumption.

21. The system of claim 19, wherein the message instructs at least one region granting permission for decreased power consumption.

22. The system of claim 19, wherein the message modifies permitted power consumption for aggregated regions.

23. The system of claim 19, wherein the data network is the Internet.

24. The system of claim 19, wherein the data network includes at least one of a wireless link and a Bluetooth connection.

25. The system of claim 19, wherein the data network contains at least one link sharing physical wiring with the utility service network.

26. The system of claim 19, wherein the means for sending the message to at least one region includes means for broadcasting the message to multiple regions.

27. The system of claim 19, wherein means for sending the message to at least one region includes means for transmitting the message as a multicast message to multiple regions.

28. The system of claim 19, wherein each region of the utility service network is classified into a class of service.

29. The system of claim 28, wherein the means for sending the message includes means for broadcasting the message to regions in the utility service network having a given class of service.

30. The system of claim 28, wherein the means for sending the message includes means for broadcasting the message to regions having a given class of service within a defined geographic area.

31. The system of claim 19, wherein the utility service is providing electricity.

32. The system of claim 19, wherein at least one region is one of a single power consuming device, a subset of a plurality of power consuming devices, a portion of the utility service network in a geographic region, and a consumption management service provider.

33. The system of claim 19, wherein the message instructs at least one region to modify at least one term or condition of sale.

34. The system of claim 33, wherein the term or condition of sale is at least one of price and a pricing method.

35. The system of claim 33, wherein modifying at least one term or condition of sale includes varying the price of the utility service based on a rate of consumption of the utility service.

36. The system of claim 19, further comprising:
means for analyzing historical data relating conditions of sale of the utility service to consumption levels of the utility service; and
means for generating the message based on the analysis of the relationship information and the analysis of the historical data.

37. A computer program product in a computer readable medium for managing a utility service, comprising:
first instructions for analyzing relationship information representing a relationship of availability of the utility service and consumption of the utility service; and
second instructions for sending a message over a data network to at least one region of a utility service network to thereby modify utility service consumption based on the analysis of the relationship information.

38. The computer program product of claim 37, wherein the message instructs at least one region permitting increased power consumption.

39. The computer program product of claim 37, wherein the message instructs at least one region permitting decreased power consumption.

40. The computer program product of claim 37, wherein the message modifies permitted power consumption for aggregated regions.

41. The computer program product of claim 37, wherein the second instructions include instructions for broadcasting the message to multiple regions.

42. The computer program product of claim 37, wherein the second instructions include instructions for transmitting the message as a multicast message to multiple regions.

43. The computer program product of claim 37, wherein each region of the utility service network is classified into a class of service.

44. The computer program product of claim 43, wherein the second instructions include instructions for broadcasting the message to regions in the utility service network having a given class of service.

45. The computer program product of claim 43, wherein the second instructions include instructions for broadcasting the message to regions having a given class of service within a defined geographic area.

46. The computer program product of claim 37, wherein the utility service is providing electricity.

47. The computer program product of claim 37, wherein at least one region is one of a single power consuming device, a subset of a plurality of power consuming devices, a portion of the utility service network in a geographic region, and a consumption management service provider.

48. The computer program product of claim 37 wherein the message instructs at least one region to modify at least one term or condition of sale.

49. The computer program product of claim 48 wherein the term or condition of sale is at least one of price and a pricing method.

50. The computer program product of claim 48, wherein modifying at least one term or condition of sale includes varying the price of the utility service based on a rate of consumption of the utility service.

51. The method of claim 1, further comprising:
third instructions for analyzing historical data relating conditions of sale of the utility service to consumption levels of the utility service; and
fourth instructions for generating the message based on the analysis of the relationship information and the analysis of the historical data.

52. A method of managing consumption of a utility, comprising:
receiving a message from a utility service provider;
generating at least one message for at least one region of a utility service network, the at least one message instructing a region to modify utility consumption by the at least one region; and
sending the at least one message to the at least one region.

53. The method of claim 52, wherein the at least one message instructs the at least one region to permit increased utility consumption.

54. The method of claim 52, wherein the at least one message instructs the at least one region to permit decreased utility consumption.

55. The method of claim 52, wherein the at least one message modifies permitted utility consumption for aggregated regions.

56. The method of claim 52, wherein sending the at least one message to the at least one region includes broadcasting the at least one message to multiple regions.

57. The method of claim 52, wherein sending the at least one message to the at least one region includes transmitting the at least one message as a multicast message to multiple regions.

58. The method of claim 52, wherein at least one region of the utility service network is classified into a class of service.

59. The method of claim 58, wherein sending the at least one message includes broadcasting the at least one message to regions in the utility service network having a given class of service.

60. The method of claim 58, wherein sending the at least one message includes broadcasting the at least one message to regions having a given class of service within a defined geographic area.

61. The method of claim 52, wherein the utility service is providing electricity.

62. The method of claim 52, wherein the at least one region is one of a single power consuming device, a subset of a plurality of power consuming devices, a portion of the utility service network in a geographic region, and a consumption management service provider.

63. The method of claim 52, wherein the at least one message instructs the at least one region to modify at least one term or condition of sale.

64. The method of claim 63, wherein the term or condition of sale is at least one of price and a pricing method.

65. The method of claim 63, wherein modifying the at least one term or condition of sale includes varying the price of the utility service based on a rate of consumption of the utility service.

66. An apparatus for managing consumption of a utility, comprising:
means for receiving a message from a utility service provider;
means for generating at least one message for at least one region of a utility service network, the at least one message being used to modify utility consumption by the at least one region; and,
means for sending the at least one message to the at least one region.

67. The apparatus of claim 66, wherein the at least one message instructs at least one region to increase utility consumption.

68. The apparatus of claim 66, wherein the at least one message instructs at least one region to decrease utility consumption.

69. The apparatus of claim 66, wherein the at least one message modifies permitted utility consumption for aggregated regions.

70. The apparatus of claim 66, wherein the means for sending the at least one message to the at least one region includes means for broadcasting at least one message to multiple regions.

71. The apparatus of claim 66, wherein the means for sending the at least one message to the at least one region includes means for transmitting the at least one message as a multicast message to multiple regions.

72. The apparatus of claim 66, wherein at least one region of the utility service network is classified into a class of service.

73. The apparatus of claim 72, wherein the means for sending the at least one message includes means for broadcasting the at least one message to regions in the utility service network having a given class of service.

74. The apparatus of claim 72, wherein the means for sending the at least one message includes means for broadcasting the at least one message to regions having a given class of service within a defined geographic area.

75. The apparatus of claim 66, wherein the utility service is providing electricity.

76. The apparatus of claim 66, wherein the at least one region is one of a single power consuming device, a subset of a plurality of power consuming devices, a portion of the utility service network in a geographic region, and a consumption management service provider.

77. The apparatus of claim 66, wherein the at least one message instructs the at least one region to modify at least one term or condition of sale.

78. The apparatus of claim 77, wherein the term or condition of sale is at least one of price and a pricing method.

79. The apparatus of claim 77, wherein modifying the at least one term or condition of sale includes varying the price of the utility service based on a rate of consumption of the utility service.

80. A computer program product in a computer readable medium for managing consumption of a utility, comprising:
first instructions for receiving a message from a utility service provider;
second instructions for generating at least one message for at least one region of a utility service network, the at least one message being used to modify utility consumption by the at least one region; and
third instructions for sending the at least one message to the at least one region.

81. The computer program product of claim 80, wherein at least one message instructs at least one region to permit increased utility consumption.

82. The computer program product of claim 80, wherein at least one message instructs at least one region to permit decreased utility consumption.

83. The computer program product of claim 80, wherein at least one message modifies permitted utility consumption for aggregated regions.

84. The computer program product of claim 80, wherein the third instructions include instructions for broadcasting at least one message to multiple regions.

85. The computer program product of claim 80, wherein the third instructions include instructions for transmitting at least one message as a multicast message to multiple regions.

86. The computer program product of claim 80, wherein each region of the utility service network is classified into a class of service.

87. The computer program product of claim 86, wherein the third instructions include instructions for broadcasting at least one message to regions in the utility service network having a given class of service.

88. The computer program product of claim 86, wherein the third instructions include instructions for broadcasting at least one message to regions having a given class of service within a defined geographic area.

89. The computer program product of claim 80, wherein the utility service is providing electricity.

90. The computer program product of claim 80, wherein at least one region is one of a single power consuming device, a subset of a plurality of power consuming devices, a portion of the utility service network in a geographic region, and a consumption management service provider.

91. The computer program product of claim 80, wherein at least one message instructs at least one region to modify at least one term or condition of sale.

92. The computer program product of claim 91, wherein the term or condition of sale is at least one of price and a pricing method.

93. The computer program product of claim 91, wherein modifying at least one term or condition of sale includes varying the price of the utility service based on a rate of consumption of the utility service.

94. A method for managing consumption of a utility, the method comprising the steps of:
receiving a message over a data network modifying permitted utility consumption of a unit; and
implementing said message modifying permitted utility consumption to thereby modify the utility consumption of the unit.

95. A method of providing a utility service, comprising:
classifying a utility consumer into a class of utility service;
determining a current status of a utility service system; and,
modifying delivery of the utility service to the utility consumer based on the current status of the utility service system.

96. The method of claim 95, wherein the class of service is a critical service class.

97. The method of claim 95, wherein the class of utility service is one of a plurality of classes of utility service, and wherein each of the plurality of classes of utility service have different priorities.

98. A method of doing business as a consumption management service provider in a utility service system, comprising:
receiving messages from at least one utility service provider; and
sending messages to at least one region of the utility service system.

99. The method of claim 98, wherein the messages sent to at least one region affect power consumption for that region.

100. The method of claim 98, wherein the messages sent to the region affects terms and conditions of sale of the utility service for that region.

101. A method for providing utility service to a customer system, comprising:
analyzing an operation of a utility system; and,
sending a message to the customer system changing a service parameter based on the analysis of the operation of the utility system.

102. The method of claim 101 wherein the message sent to the customer system instructs the customer system to change the service parameter such that the customer system ceases operations.

103. The method of claim 101 wherein the message sent to the customer system instructs the customer system to change the service parameter such that the customer system resumes operations.

104. The method of claim 101 wherein the message sent to the customer system instructs the customer system to change the service parameter such that the customer system consumes decreased power supply.

105. The method of claim 101 wherein the message sent to the customer system instructs the customer system to change the service parameter such that the customer system consumes increased power supply.

106. The method of claim 101 wherein the utility service auctions a class of utility service.

107. The method of claim 106 wherein the auction is based on the amount of the utility service available for each class of utility service.

108. The method of claim 106 wherein the utility service auctions a class of utility service, wherein the auction is based on the price of the utility service for each class of utility service.

109. The method of claim 101 wherein the class of utility service is set by a predetermined price of utility service.

110. The method of claim 101 wherein the utility service is electricity.

111. The method of claim 101 wherein the utility service is a communications link.

112. An apparatus for providing utility service to a customer system, comprising:
means for analyzing an operation of an utility system; and
means for sending a message to the customer system changing a service parameter based on the analysis of the operation of the utility system.

113. A method of receiving utility service by a customer system, comprising:
receiving a message from a utility service to change a service parameter of the utility service provided to a customer system; and
changing the service parameter of the utility service supplied to the customer system.

114. The method of claim 113 wherein the message received by the customer system instructs the customer system to change the service parameter, wherein the customer system ceases operations.

115. The method of claim 113 wherein the message received by the customer system instructs the customer system to change the service parameter, wherein the customer system resumes operations.

116. The method of claim 113 wherein the message received by the customer system instructs the customer system to change the service parameter, wherein the customer system consumes decreased power supply.

117. The method of claim 113 wherein the message received by the customer system instructs the customer system to change the service parameter, wherein the customer system consumes increased power supply.

118. The method of claim 113 wherein the customer system negotiates a class of utility service with the utility service.

119. The method of claim 113 wherein the customer system negotiates a class of utility service with the utility service, wherein the negotiation is based on the amount of the utility service available for each class of utility service.

120. The method of claim 113 wherein the customer system negotiates a class of utility service with the utility service, wherein the negotiation is based on the price of the utility service for each class of utility service.

121. The method of claim 113 wherein the customer system participates in an auction for a class of utility service.

122. The method of claim 121 wherein the auction is based on the amount of the utility service available for each class of utility service.

123. The method of claim 121 wherein the auction is based on the price of the utility service for each class of utility service.

124. The method of claim 118 wherein the class of utility service is set by a predetermined amount of utility service.

125. The method of claim 118 wherein the class of utility service is set by a predetermined price of utility service.

126. The method of claim 113 wherein the utility service is electricity.

127. The method of claim 113 wherein the utility service is a communications link.

128. An apparatus for receiving utility service by a customer system, comprising:
means for receiving a message from a utility service to change a service parameter of the utility service provided to a customer system;
means for accepting the message from the utility service; and,
means for changing the service parameter of the utility service supplied to the customer system.

129. A method of doing business for providing utility service, comprising:
analyzing an operation of an utility system;
associating a customer system with a class of utility service;
sending a message to the customer system changing the service parameter of the utility service provided to the customer system in response to a change in the operation of the utility system.

130. The method of claim 129 wherein the association of a customer system with a class of utility service is dynamic.

131. The method of claim 129 wherein the association of a customer system with a class of utility service may be changed unilaterally by the utility service.

132. The method of claim 129 wherein the change in the class of utility service provided to the customer system is based on a cost increase in utility service.

133. The method of claim 129 wherein the change in the class of utility service provided to the customer system is based on a cost decrease in utility service.

134. The method of claim 129 wherein the change in the class of utility service provided to the customer system is based on an increase in the available amount of utility service.

135. The method of claim 129 wherein the change in the class of utility service provided to the customer system is based on a decrease in the available amount of utility service.

136. The method of claim 129 wherein the change in the class of utility service provided to the customer system is based on auctioning an amount of utility service.

137. The method of claim 129 wherein the class of utility service has pricing which depends on the amount of the utility service demanded in aggregate by the utility system.

138. The method of claim 129 wherein the class of utility service has pricing achieved by auction.

139. The method of claim 129 wherein the customer system is represented in the auction by a policy.

140. The method of claim 129 wherein the association with a class of utility service is based on the time of day.

141. The method of claim 129 wherein the association with a class of utility service is based on price of goods.

142. The method of claim 129 wherein the association with a class of utility service is based on optimization.

143. The method of claim 129 wherein the optimization is on behalf of the user.

144. The method of claim 129 wherein the customer system determines the class of utility service it will receive.

145. The method of claim 129 wherein the customer system negotiates the class of utility service it will receive.

146. The method of claim 129 wherein the class of utility service depends on the customer system identification.

147. The method of claim 129 wherein the customer system identifies itself to the utility service provider with at least one identification address.

148. A method for providing utility service comprising:
receiving an instruction to modify consumption of the utility service,
identifying a class of utility service for a customer system connected to the utility system; and
sending a message to the customer system changing the class of utility service provided to the customer system to thereby modify consumption of the utility service.

149. The method of claim 148 wherein the message sent to the customer system instructs the customer system to accept a different class of utility service such that the customer system ceases operations.

150. The method of claim 148 wherein the message sent to the customer system instructs the customer system to accept a different class of utility service such that the customer system resumes operations.

151. The method of claim 148 wherein the message sent to the customer system instructs the customer system to accept a different class of utility service such that the customer system consumes decreased power supply.

152. The method of claim 148 wherein the message sent to the customer system instructs the customer system to accept a different class of utility service such that the customer system consumes increased power supply.

153. The method of claim 148 wherein the service provider facilitates auctioning a class of utility service.

154. The method of claim 153 wherein the auction is based on the amount of the utility service available for each class of utility service.

155. The method of claim 153 wherein the auction is based on the price of the utility service for each class of utility service.

156. The method of claim 148 wherein the class of utility service is set by a predetermined price of utility service.

157. The method of claim 148 wherein the utility service is electricity.

158. The method of claim 148 wherein the utility service is a communications link.

159. A computer program product for providing utility service to a customer system, comprising:
first instructions for analyzing an operation of an utility system;
second instructions for identifying a class of utility service for a customer system connected to the utility system; and,
third instructions for sending a message to the customer system changing the class of utility service provided to the customer.

160. The computer program product of claim 159 further comprising:
fourth instructions for changing the class of utility service provided to the customer system based on the service provider's analysis of the operation of the utility system.

161. The computer program product of claim 159 further comprising:
fifth instructions for instructing the customer system to accept a different class of utility service such that wherein the customer system should cease operations.

162. The computer program product of claim 159 further comprising:
sixth instructions for instructing the customer system to accept a different class of utility service, wherein the customer system resumes operations.

163. The computer program product of claim 159 further comprising:
seventh instructions for instructing the customer system to accept a different class of utility service, wherein the customer system consumes decreased power supply.

164. The computer program product of claim 159 further comprising:
eighth instructions for instructing the customer system to accept a different class of utility service, wherein the customer system consumes increased power supply.

165. The computer program product of claim 159 further comprising:
ninth instructions for facilitating an auction of the class of utility service, wherein the auction is based on the amount of the utility service available for each class of utility service.

166. The computer program product of claim 159 further comprising:
tenth instructions for facilitating an auction of the class of utility service.

167. The computer program product of claim 166 wherein the auction is based on the price of the utility service for each class of utility service.

168. The computer program product of claim 159 further comprising:
eleventh instructions for facilitating an auction of the class of utility service such that the auction is based on the availability of the utility service for each class of utility service.

169. The computer program product of claim 159 further comprising:
twelfth instructions for instructing a customer system to accept a different class of utility service, wherein the class of utility service is set by a predetermined price of utility service.

170. The computer program product of claim 159 further comprising:
thirteenth instructions for assigning the customer system a new level of utility service, wherein the class of utility service is set by a negotiated amount of utility service.

171. A computer program product for receiving utility service by a customer system, comprising:
first instructions for receiving a message from a utility service to change a class of utility service to a customer system;
second instructions for accepting the message from the utility service; and,
third instructions for changing the class of utility service supplied to the customer system.

172. The computer program product of claim 171 further comprising:
fourth instructions for instructing the customer system to accept a different class of utility service, wherein the customer system ceases operations.

173. The computer program product of claim 171 further comprising:
fifth instructions for instructing the customer system to accept a different class of utility service, wherein the customer system resumes operations.

174. The computer program product of claim 171 further comprising:
sixth instructions for instructing the customer system to accept a different class of utility service, wherein the customer system consumes decreased power supply.

175. The computer program product of claim 171 further comprising:
seventh instructions for instructing the customer system to accept a different class of utility service, wherein the customer system consumes increased power supply.

176. The computer program product of claim 171 further comprising:
eighth instructions for instructing the customer system to negotiate a class of utility service with the utility service.

177. The computer program product of claim 171 further comprising:
ninth instructions for instructing the customer system to negotiate a class of utility service with the utility service.

178. The computer program product of claim 171 further comprising:
tenth instructions for instructing the customer system to negotiate a class of utility service with the utility service, wherein the negotiation is based on the price of the utility service for each class of utility service.

179. The computer program product of claim 171 further comprising:
eleventh instructions for instructing the customer system to participate in an auction for a class of utility service.

180. The computer program product of claim 171 further comprising:
twelfth instructions for instructing the customer system to participate in an auction for a class of utility service, wherein the auction is based on the price of the utility service for each class of utility service.

181. The computer program product of claim 171 further comprising:
thirteenth instructions for instructing the customer system to accept a different class of utility service, wherein the class of utility service is set by a predetermined amount of utility service.

182. The computer program product of claim 171 further comprising:
fourteenth instructions for instructing the customer system to accept a different class of utility service, wherein the class of utility service is set by a predetermined price of utility service.

183. A computer program product for providing utility service comprising:
first instructions for receiving an instruction to modify consumption of the utility service;
second instructions for identifying a class of utility service for a customer system connected to the utility system; and
third instructions for sending a message to the customer system changing the class of utility service provided to the customer system to thereby modify consumption of the utility service.

184. The computer program product of claim 183 further comprising:
fourth instructions for changing the class of utility service provided to the customer system such that the customer system ceases operations.

185. The computer program product of claim 183 further comprising:
fifth instructions for changing the class of utility service provided to the customer system such that the customer system resumes operations.

186. The computer program product of claim 183 further comprising:
sixth instructions for changing the class of utility service provided to the customer system such that the customer system consumes decreased power supply.

187. The computer program product of claim 183 further comprising:
seventh instructions for changing the class of utility service provided to the customer system such that the customer system consumes increased power supply.

188. The computer program product of claim 183 further comprising:
eighth instructions for auctioning the class of utility service provided to the customer system such that the auction is based on the amount of the utility service available for each class of utility service.

189. The computer program product of claim 183 further comprising:
ninth instructions for auctioning the class of utility service provided to the customer system such that the auction is based on the price of the utility service for each class of utility service.

190. The computer program product of claim 183 further comprising:
tenth instructions for changing the class of utility service provided to the customer system, wherein the class of utility service is set by a predetermined price of utility service.
